(19) United States
(12) Patent Application Publication
(10) Pub. No.: US 2026/0300617 A1
(43) Pub. Date: Oct. 1, 2026

(54) AUTOMATED GENERATION OF VISUAL REPRESENTATIONS OF DOCUMENTS

(71) Applicant: eBay Inc., San Jose, CA (US)

(72) Inventor: Shrivatsan Navalpakkam Rajagopalan, San Jose, CA (US)

(73) Assignee: eBay Inc., San Jose, CA (US)

(21) Appl. No.: 19/090,078

(22) Filed: Mar. 25, 2025

(51) Int. Cl. G06F 40/186; G06F 40/197; G06F 40/205; G06N 3/0895

(52) U.S. Cl. CPC G06F 40/186; G06F 40/197; G06F 40/205; G06N 3/0895

(57) ABSTRACT

A system for automatically generating visual representations of documents is described. The system may be provided documents that include information about strategic planning of an organization, such as roadmap documents. Information in the document may be organized according to a template format. The system may chunk and encode content (e.g., text) of the documents to generate a corresponding vector embedding index. A large language model (LLM) may execute to distill sections of the documents, for example, based on categories of information, and the LLM may generate a file based on the vector embedding index and the distilled sections. The file may include a syntax for generating a visual representation of the information. In some examples, a visualization tool may be used to generate the visual representation. The visual representation may be sent for display via a user interface of a computing device.

### BACKGROUND

Organizations (e.g., businesses) may participate in strategic planning (e.g., roadmap planning) to instruct and encourage their members or employees to work toward common goals. Such strategic planning may involve some members of an organization creating documents that outline the organization's values, obstacles, goals, and other metrics. The documents, which may be considerably long and detailed, may be edited, updated, and shared between leadership, employees, and other members of the organization.

### SUMMARY

Automatic generation of visual representations of documents is leveraged for organizations. In one or more implementations, strategic planning documents are obtained from members of an organization. For example, executives of a business or corporation may draft strategic planning documents to relay information about their mission, vision, goals, and other metrics throughout the business. Such strategic planning is also referred to herein as roadmap planning. A system may chunk and encode contents (e.g., text) of the documents to generate a vector embedding index. Using the vector embedding index, an artificial intelligence (AI) model, such as a large language model (LLM), may execute to distill sections of the document and output a corresponding file. The output file may include a syntax instructing a visualization module to generate a visual representation of the information contained in the documents. The visual representation may depict the information in a graphical, pictorial, or other visual format, which may be simpler to understand and easier to distribute to other people in the organization. Once generated, the visual representation may be sent to a user device and displayed via a user interface of any relevant user (e.g., employees, members, etc.).

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures.

FIG. 1 is an illustration of an environment in an example implementation that is operable to employ techniques described herein.

FIG. 2 depicts an example of a document in accordance with aspects of the present disclosure.

FIG. 3 depicts an example of a visual representation in accordance with aspects of the present disclosure.

FIG. 4 depicts a procedure in an example implementation of automatic generation of visual representations of documents in accordance with the aspects of the present disclosure.

FIG. 5 illustrates an example of a system that includes an example computing device that is representative of one or more computing systems and/or devices that may implement the various techniques described herein.

### DETAILED DESCRIPTION

### Overview

A system for automatically generating visual representations of documents for an organization is described. An organization (e.g., a business, company, corporation, or other entity) may participate in strategic planning (e.g., roadmap planning) to define and communicate the organization's vision, goals, obstacles, and other metrics. For example, executives of a company may use strategic planning frameworks, such as a Vision, Values, Methods, Obstacles, and Measures (V2MOM) framework, to help align their employees toward a single goal and inter-organizational objectives, navigate changes, organize different departments and employees, and so forth.

Such strategic planning, however, may be difficult for large organizations. It may be challenging for large organizations to share a roadmap or other document between business units, departments, and employees due to their size. If roadmaps or other documents are shared throughout the organization, it may be difficult to do so in a streamlined manner. For example, different employees may communicate with supervisors and other team members in different ways, and it may not be possible to verify that each employee received and reviewed a document. Additionally, strategic planning documents may include significant amounts of information and be considerably long. As a result, it may be burdensome for more than several people to provide inputs, draft, and update the document in a reliable and consistent manner. Text edits may not be tracked, different versions may be sent to different people, and some people may be left out of the drafting process entirely. Current systems are unable to distill the information of such documents into simple, visual formats that numerous parties may contribute to, and that can be easily distributed through large organizations.

To address these limitations, techniques for automatically generating visual representations of documents are described. In one or more implementations, the described techniques involve a visual representation platform, including an LLM, implemented for an organization to create a visualization of the organization's strategic planning. Members of the organization may draft a document related to strategic planning for the organization (e.g., a roadmap). The document may be drafted in a template format, where the contents of the document may be organized into different categories. The visual representation platform may chunk and encode contents of the document into a vector-embedding index.

An LLM may execute to distill sections of the documents, and based on the distilled sections and the vector embedding index, generate and output a text file. For example, the document may be distilled into executive-pertinent sections (e.g., sections of the template that organize the document, such as vision, goals, obstacles, and so forth). The text file may include a syntax for generating a visual representation of the information included in the document. In some examples, the text file may be sent to a visualization module that may use the syntax to generate the visual representation. The visual representation may include graphs, charts, images, or other visualizations showing the distilled sections of the document, which may be displayed via a user interface of a user device (or multiple user devices of relevant users). The visual representation may be easier to draft, understand, and distribute throughout the organization than the underlying document.

The described techniques may result in several improvements, including faster processing, improved data storage and data retrieval efficiency, and enhanced graphical user interface (GUI) features, among other improvements. For example, by chunking and encoding content of the documents to generate a vector embedding index, the techniques may result in more efficient storage of the content and more efficient data retrieval for the LLM. In addition, data retrieval efficiency is improved by leveraging documents that have a template format, where the LLM processes the document with knowledge of the template format. For example, the LLM may be trained on language commonly used by businesses, which may form the basis of the syntax generated by the LLM. Additionally, generating the visual representation based on distilled sections of the document and the syntax rather than the original format may result in faster processing. The described techniques may also enhance GUI features by providing users a graphical, pictorial, illustrative, or other visual representation of the document, which may be easier to interpret, edit, and distribute.

In some aspects, the techniques described herein relate to a computer-implemented method including: obtaining one or more documents that include information about strategic planning of an organization; generating a vector embedding index corresponding to the one or more documents based on chunking and encoding content of the one or more documents; executing an LLM to distill sections of the one or more documents and generate a text file based on the vector embedding index and the distilled sections, wherein the text file comprises a syntax for generating a visual representation of the information; and sending, for display via a user interface, the visual representation of the information.

In some aspects, the techniques described herein relate to a computer-implemented method, wherein the information is included in the one or more documents according to a template format.

In some aspects, the techniques described herein relate to a computer-implemented method, wherein the template format is used to train the LLM.

In some aspects, the techniques described herein relate to a computer-implemented method, wherein the syntax for generating the visual representation indicates one or more categories of the information, wherein the one or more categories relate to the strategic planning.

In some aspects, the techniques described herein relate to a computer-implemented method, further including: sending, to a visualization module, the file, wherein the visual representation is generated based on the syntax.

In some aspects, the techniques described herein relate to a computer-implemented method, further including: monitoring for at least one or more additional documents or a change to the information; and generating an updated vector embedding index based on the at least one or more additional documents or the change to the information.

In some aspects, the techniques described herein relate to a computer-implemented method, further including obtaining a plurality of documents including the one or more documents; chunking and encoding the content within each of the plurality of documents by taking a plurality of characters of text within the content as a first chunk and overlapping a portion of the plurality of characters, and by taking a second plurality of characters of the text as a second chunk and overlapping a portion of the second plurality of characters to generate coherence across multiple chunks; providing the chunked and encoded content to the vector embedding index; based on providing the chunked and encoded content to the vector embedding index, utilizing the LLM to distill sections for the plurality of documents; and sending, for display via the user interface, a distilled version of each of the plurality of documents into a standardized GUI.

In some aspects, the techniques described herein relate to a computer-implemented method further including: utilizing the LLM to distill the sections for the plurality of documents based on the vector embedding index utilizing the first chunk, the second chunk, and a chunk identifier (ID) for each of the first chunk and the second chunk to perform a reverse mapping.

In some aspects, the techniques described herein relate to a computer-implemented method, wherein the plurality of characters and the second plurality of characters are below a threshold.

In some aspects, the techniques described herein relate to a system including: one or more processors; and memory storing instructions that, when executed by the one or more processors, cause the system to: obtain one or more documents that include information about strategic planning of an organization; generate a vector embedding index corresponding to the one or more documents based on chunking and encoding content of the one or more documents; execute an LLM to distill sections of the one or more documents and generate a text file based on the vector embedding index and the distilled sections, wherein the text file comprises a syntax for generating a visual representation of the information; and send, for display via a user interface, the visual representation of the information.

In some aspects, the techniques described herein relate to a system, wherein the information is included in the one or more documents according to a template format.

In some aspects, the techniques described herein relate to a system, wherein the template format is used to train the LLM.

In some aspects, the techniques described herein relate to a system, wherein the syntax for generating the visual representation indicates one or more categories of the information, wherein the one or more categories relate to the strategic planning.

In some aspects, the techniques described herein relate to a system, wherein the instructions further cause the system to send, to a visualization module, the file, wherein the visual representation is generated based on the syntax.

In some aspects, the techniques described herein relate to a system, wherein the instructions further cause the system to monitor for at least one or more additional documents or a change to the information; and generating an updated vector embedding index based on the at least one or more additional documents or the change to the information.

In some aspects, the techniques described herein relate to a system, wherein the instructions further cause the system to obtain a plurality of documents including the one or more documents; chunking and encoding the content within each of the plurality of documents by taking a plurality of characters of text within the content as a first chunk and overlapping a portion of the plurality of characters, and by taking a second plurality of characters of the text as a second chunk and overlapping a portion of the second plurality of characters to generate coherence across multiple chunks; providing the chunked and encoded content to the vector embedding index; based on providing the chunked and encoded content to the vector embedding index, utilize the LLM to distill sections for the plurality of documents; and sending, for display via the user interface, a distilled version of each of the plurality of documents into a standardized GUI.

In some aspects, the techniques described herein relate to a system, wherein the instructions further cause the system to utilize the LLM to distill the sections for the plurality of documents based on the vector embedding index utilizing the first chunk, the second chunk, and a chunk ID for each of the first chunk and the second chunk to perform a reverse mapping.

In some aspects, the techniques described herein relate to a system, wherein the plurality of characters and the second plurality of characters are below a threshold.

In some aspects, the techniques described herein relate to a non-transitory computer-readable media storing instructions that, when executed by one or more processors, cause the one or more processors to perform operations including: obtaining one or more documents that include information about strategic planning of an organization; generating a vector embedding index corresponding to the one or more documents based on chunking and encoding content of the one or more documents; executing an LLM to distill sections of the one or more documents and generate a text file based on the vector embedding index and the distilled sections, wherein the text file comprises a syntax for generating a visual representation of the information; and sending, for display via a user interface, the visual representation of the information.

In the following discussion, an exemplary environment is first described that may employ the techniques described herein. Examples of implementation details and procedures are then described which may be performed in the exemplary environment as well as other environments. Performance of the exemplary procedures is not limited to the exemplary environment and the exemplary environment is not limited to performance of the exemplary procedures.

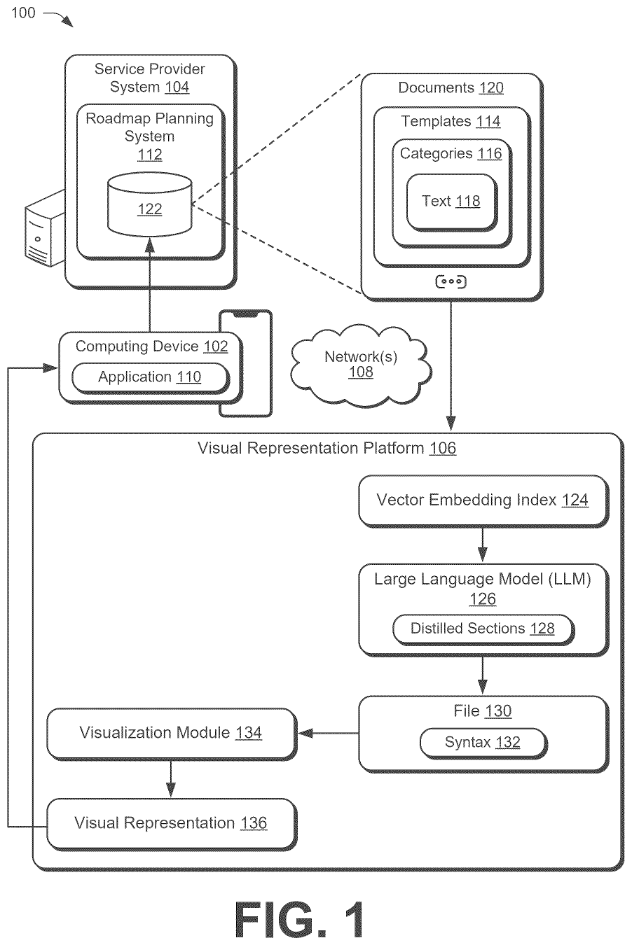

FIG. 1 is an illustration of an environment 100 in an example implementation that is operable to employ techniques described herein. The environment 100 includes a computing device 102, a service provider system 104, and a visual representation platform 106. In one or more implementations, the computing device 102, the service provider system 104, and the visual representation platform 106 are communicatively coupled, one to another, via network(s) 108. One example of the network(s) 108 is the Internet, although one or more of the computing device 102, the service provider system 104, and the visual representation platform 106 may be communicatively coupled using one or more different connections or different networks in various implementations (e.g., a cloud).

Although the visual representation platform 106 is depicted in the environment 100 as being separate from the computing device 102 and the service provider system 104, in one or more implementations, an entirety or various portions of the visual representation platform 106 are implemented at or by the computing device 102 and/or the service provider system 104. In at least one implementation, for example, at least a portion of the visual representation platform 106 is implemented by an application 110 of the computing device 102 and/or using various resources of the computing device 102, such as hardware resources, an operating system, firmware, and so forth. Additionally, or alternatively, at least a portion of the visual representation platform 106 is implemented by resources (e.g., server-based storage, processing, and so on) of the service provider system 104. Additionally, or alternatively, at least a portion of the visual representation platform 106 is implemented using a third-party service, such as a web services platform that provides one or more hardware and/or other computing resources to support provision of services by web service providers.

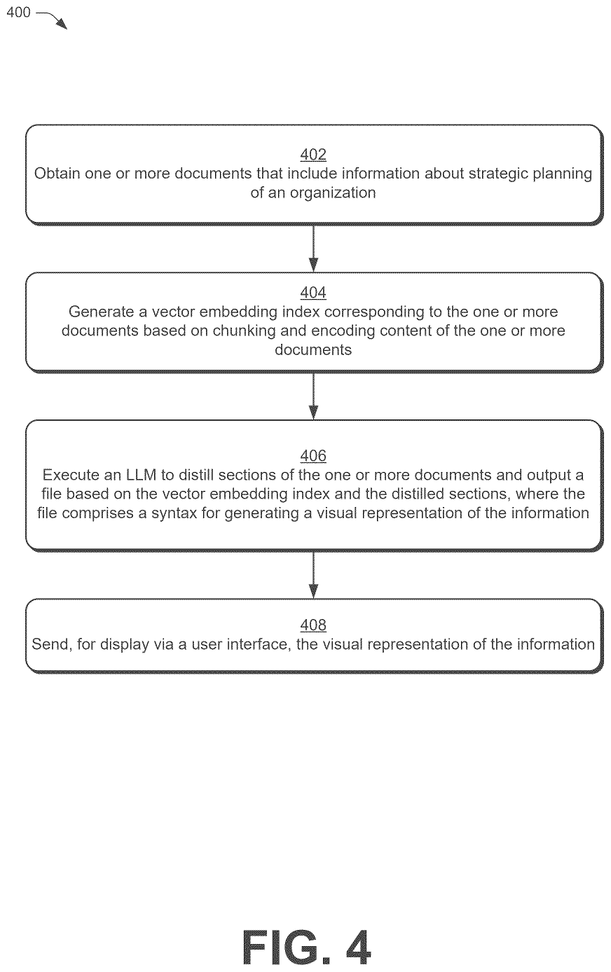

Computing devices that implement the environment 100 are configurable in a variety of ways. A computing device (e.g., computing device 102), for instance, is configurable as a desktop computer, a laptop computer, a mobile device (e.g., assuming a handheld configuration such as a tablet or mobile phone), an Internet-of-Things (IoT) device, a wearable device (e.g., a smart watch, a ring, or smart glasses), an augmented reality (AR)/virtual reality (VR) device (e.g., smart glasses), a server, and so forth. Thus, a computing device ranges from full resource devices with substantial memory and processor resources to low-resource devices with limited memory and/or processing resources. Additionally, although in instances in the following discussion reference is made to a computing device in the singular, a computing device is also representative of a plurality of different devices, such as multiple servers of a server farm or data center utilized to perform operations “over the cloud” as further described in relation to FIG. 4.

In at least one implementation, an application 110 supports communication of data across the network(s) 108, such as between the computing device 102 and the service provider system 104 and/or between the computing device 102 and the visual representation platform 106. By supporting such data communication, the application 110 provides a respective user of the computing device 102 (and users of other computing devices) access to a roadmap planning system 112. For example, the computing device 102 receives data from the service provider system 104. Based on the received data, the application 110 causes various systems of the computing device 102 to output user interfaces of the roadmap planning system 112, such as by displaying user interfaces via display devices or making accessible voice-based user interfaces.

Through interaction of a user with the computing device 102, the application 110 receives user input via one or more user interfaces of the roadmap planning system 112 and/or visual representation platform 106. Examples of such input include, but are not limited to, receiving touch input in relation to portions of a displayed user interface, receiving one or more voice commands, receiving typed input (e.g., via a physical or virtual (“soft”) keyboard), receiving mouse or stylus input, and so forth. One example of the application 110 is a browser, which is operable to navigate to a website of the roadmap planning system 112, display pages of the website, facilitate user interaction with web pages of the roadmap planning system 112's website, and search for listings, items, and/or functionality of the roadmap planning system 112. Another example of the application 110 is a web-based computer application of the roadmap planning system 112, such as a mobile application or a desktop application. The application 110 may be configured in different ways, which enable users to interact with their computing devices and by extension perform actions on the roadmap planning system 112, without departing from the spirit or scope of the techniques described herein.

Broadly speaking, the roadmap planning system 112 provides functionality for creating and updating strategic planning documents (e.g., documents 120) or roadmaps for an organization. Such documents 120 may follow templates 114 or frameworks that help the organization set goals, organize teams, and so forth, such as a V2MOM framework, a strengths, weaknesses, opportunities, and threats (SWOT) analysis, a strategic alignment model, or any other type of formal specification or section template-based goals document of an organization. In some examples, the templates 114 may be organized based on categories 116, which may correspond to executive-pertinent sections. For example, a V2MOM document may be organized into the categories 116 of vision, values, methods, obstacles, and measures. The organization may be a business, company, corporation, or entity of any size (e.g., a small start-up company, a Fortune 500 company, and so forth). Each category 116 may include text 118 that describes the organization's strategic planning in the context of that category 116. For example, if a category 116 is “goals,” the corresponding text 118 may describe the company's goals.

In the environment 100, the roadmap planning system 112 includes a storage device 122, which is depicted as maintaining data (e.g., content, information) in the documents 120. The storage device 122 may represent one or more databases and/or other types of storage capable of storing the documents 120. Examples of the storage device 122 include, but are not limited to, mass storage and virtual storage. In one or more implementations, for example, the storage device 122 may be virtualized across a plurality of data centers and/or cloud-based storage devices. The service provider system 104 may implement the roadmap planning system 112 by using servers that execute stored instructions to deploy various services of the service provider system 104, such that those services perform numerous computations which are effective to provide the functionality described above and below. It is to be appreciated that the roadmap planning system 112 may include more, fewer, or different components without departing from the spirit or scope described herein.

In one or more implementations, the roadmap planning system 112 is accessible by decentralized computing devices that correspond to “clients” of the roadmap planning system 112, e.g., users that have permissions to access the roadmap planning system 112. For example, executives of the organization may have access to the roadmap planning system 112, though different members of the organization may be granted access at any given point. In this way, users may utilize the roadmap planning system 112 to create the documents 120.

In one or more implementations, the roadmap planning system 112 saves and maintains the data for a document 120 in the storage device 122 in fields of a data structure or data record populated for a template 114, where a given field and the information populated and maintained for the given field correspond to particular text of a particular category 116 of the template 114. For instance, a ‘goals’ field of such a data structure or data record may be populated with information (e.g., text 118) relating to a ‘goals’ category 116 input into a user interface by a user. In one or more implementations, one or more of the category 116 of a template 114 may be derived and then populated by the roadmap planning system 112, such as by the roadmap planning system 112 processing one or more portions of the information input by a user to populate one or more respective categories 116 of the documents 120.

To generate a visual representation 136 of a document 120 as described herein, the visual representation platform 106 may obtain one or multiple documents 120. The documents 120 may be provided to the visual representation platform 106, including an LLM 126, in a variety of formats such as portable document format (PDF), HyperText Markup Language (HTML), Extensible Markup Language (XML), Document Office XML (DocX), text (txt), document (Doc), OpenDocument Format (ODF), Rich Text Format (RTF), and so forth.

The visual representation platform 106 may chunk and encode content of the documents 120 (e.g., including the templates 114, categories 116, and text 118) to generate a vector embedding index 124 corresponding to the documents 120. Generating the vector embedding index 124 may include transforming the content of the documents 120 into a vector format that allows the documents to be processed by the LLM 126. In one or more implementations, the vector embedding index 124 may chunk and encode the content of each document 120 using various overlapping characters in the text content. A character may include any single unit of text, including individual letters, numbers, punctuation marks, spaces, or other symbols. As such, the vector embedding index 124 is a data structure used to store vector embeddings of chunks of text for efficient retrieval and utilization. The vector embedding index 124 may store (e.g., index) the vectors in such a way that similar vectors representing similar chunks of text are near each other.

The visual representation platform 106 may take a set of characters of the text 118 within the content as a first chunk and overlap a portion of the set of characters, and a second set of characters of the text 118 as a second chunk and overlap a portion of the second set of characters to generate coherence across multiple chunks. Coherence refers to the consistency between the multiple chunks of characters as they are encoded such that the context of the document is preserved across the chunks. That is, overlapping the portions of the sets of characters may connect the chunks in a logical manner. The sets of characters may each include a quantity of characters below a threshold quantity. For example, using various overlapping characters in the text content, a single chunk may include one hundred characters or more, and twenty characters may be overlapped to create the coherence across the multiple chunks.

The chunked and encoded content may be provided to the vector embedding index, and the vector embedding index 124 may use the one-hundred-character chunks along with a chunk ID to reverse map and identify the chunks. A chunk ID may be a unique identifier associated with a specific chunk that enables the overall structure of the document to remain intact when it is chunked and encoded. Chunk IDs may also provide for more efficient processing by maintaining reference of the chunks to their original structure in the document. Chunk IDs may be numeric, sequential, hierarchical, or of some other format. After the text in the document is chunked and encoded to vectors, reverse mapping may allow for tracing back the vectors to the chunks of the original text (e.g., using the chunk IDs). That is, the actual text that corresponds to an encoded vector can be identified.

Utilizing chunks that are too long (e.g., related to a threshold chunk length) may result in signal-loss in recall and noise infusion. Instead, chunking the content as described herein results in a relatively higher signal-to-noise ratio (e.g., compared to utilizing longer chunks) and influences the overall quality of vector embedding index 124 recall.

The vector embedding index 124 may be provided to the LLM 126 to distill sections 128 of the documents 120. The LLM 126 may be supported by the visual representation platform 106. The LLM 126 may be a type of generative AI model (e.g., a multi-modal model), including open source models or AI models fine-tuned for the purpose of generating visual representations of strategic planning documents. The LLM 126 may be trained on the templates 114 and the categories 116 to distill sections 128 of the documents 120. In some cases, the LLM 126 may use the first and second chunks of characters and the corresponding chunk IDs to perform a reverse mapping in order to distill sections 128 of the documents 120. Each distilled section 128 of a document 120 may correspond to a category 116 of the template 114 corresponding to that document 120. That is, each distilled section 128 may correspond to a category 116, and may depict the corresponding text 118. In some examples, the visual representation platform 106 may send a distilled version of each of the documents 120 (e.g., including the distilled sections 128) into a standardized GUI for display via a user interface of the computing device 102.

The LLM 126 may generate a file 130 based on the vector embedding index 124 and the distilled sections 128. The file 130 may be a text file, a scalable vector graphics (SVG) file, an HTML file or a file of other formats which may represent content of the documents (e.g., a mindmap). In some implementations, the file 130 may include syntax 132 for generating the visual representation 136 of information included in the documents 120. The syntax 132 may include text that is sufficient for creating visual representations of the documents 120 (e.g., similar to HTML). For example, the syntax 132 may indicate the categories 116, the text 118 itself, and any other information about the documents 120, in addition to instructions for depicting the information visually. The file 130 and the syntax 132 may be of a format that is compatible with the storage device 122, such that the file 130 may be stored at the storage device 122 for subsequent visual rendering. Additionally, or alternatively, the file 130 and the syntax 132 may be stored in object-storage buckets, offline servers, online servers, FTP file-systems, non-volatile memory express (NVMe) storage, or any other form of storage accessible from the computing device via the network(s) 108.

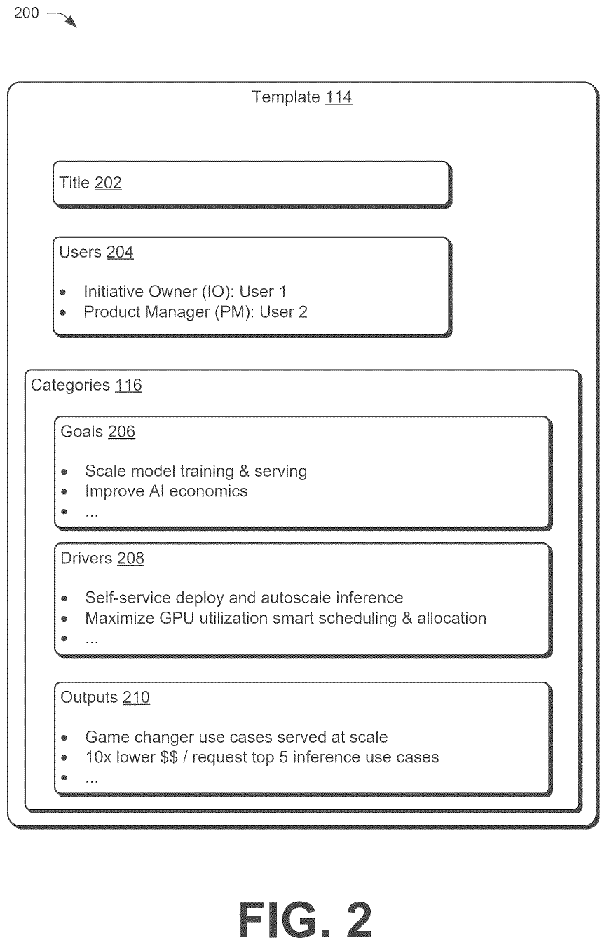

In some examples, the visual representation platform 106 may send the file 130 and the syntax 132 to a visualization module 134, which may generate the visual representation 136 based on the syntax 132. The visualization module 134 may be a diagramming and charting tool (e.g., an open-source tool) for rendering a pictorial, graphical, illustrative, or other visual representation 136 of the information in the documents 120. That is, the visualization module 134 may render the syntax 132, which communicates a summary of the information in the documents 120, in some sort of diagram. An example of the visual representation 136 is described herein with reference to FIG. 2.

The visual representation platform 106 may share (e.g., communicate) the visual representation 136 across the network(s) 108 to one or more computing devices, including to the computing device 102. The visual representation platform 106 may share the visual representation 136 to computing devices, such that users of the computing devices can interact with the visual representation 136 via user interfaces. For example, the users may use the visual representation 136 to communicate their organizations goals throughout the organization. The visual representation 136 may be simpler than the underlying documents 120, and thus easier to understand and distribute.

In some implementations, the visual representation platform 106 may monitor for additional documents 120 or a change to the documents 120. For example, a user may add text 118 or a new category 116 to a document 120 that the visualization module 134 has already generated the visual representation 136 for. In such cases, the visual representation platform 106 may generate an updated vector embedding index based on the additional documents 120 or the change, and the visual representation platform 106, the LLM 126, and the visualization module 134 may operate as described herein to generate an updated visual representation 136. Alternatively, the visualization module 134 may support a functionality in which a user may interact with a user interface of the visualization module 134 update the syntax 132 according to a change in a document 120, and the visualization module 134 may generate an updated visual representation according to the updated syntax.

Having considered an example of an environment, consider now a discussion of some example details of the techniques for automatically generating visual representations of documents in accordance with one or more implementations.

FIG. 2 depicts an example of a document 200 in accordance with aspects of the present disclosure. The document 200 may be implemented in or otherwise supported by the computing device 102, the service provider system 104, and the visual representation platform 106, as described with reference to FIG. 1. For example, the document 200 may be an example of a document 120 described herein with reference to FIG. 1.

The document 200 may be formatted using a template 114, which may include different fields or sections such as a title 202, users 204, and categories 116. As discussed in FIG. 1, the template 114 may correspond to a framework that helps an organization set goals, organize teams, and so forth, such as a V2MOM framework. For example, the title 202 may be “2025 Initiative V2MOM.” The users 204 may indicate members of the organization (e.g., executives or other leaders) that initially create the document 200. The users 204 may have permissions or otherwise be granted access to the document 200. For example, the users 204 may include an initiative owner (IO) (e.g., User 1) and a product manager (PM) (e.g., User 2), among other users.

In the example of FIG. 2, the categories 116 may correspond to executive-pertinent sections, or sections that relate to the organization's strategic planning in the context of the template 114. For example, if the template 114 follows a V2MOM framework, the categories 116 may correspond to executive-pertinent sections including vision, values, methods, obstacles, and measures. In this way, each category 116 may detail some aspect of the organization's strategic planning. The template 114 may include categories 116 such as goals 206, drivers 208, and outputs 210. The goals 206 category may include text relating to the organization's goals, such as “scale model training and serving,” “improve AI economics,” and so forth. The drivers 208 category may include text relating to the organization's key drivers, such as “self-service deploy and autoscale inference,” “maximize graphics processing unit (GPU) utilization smart scheduling and allocation,” and so forth. The outputs 210 category may include text relating to the organization's key outputs, such as “game changer use cases served at scale,” “10× lower $$/request top 5 inference use cases,” and so forth.

The categories 116, which may be referred to as executive-pertinent sections. For example, a V2MOM document may be organized into the categories 116 of vision, values, methods, obstacles, and measures. The organization may be a business, company, corporation, or entity of any size (e.g., a small start-up company, a Fortune 500 company, and so forth). Each category 116 may include text 118 that describes the organization's strategic planning in the context of that category 116. For example, if a category 116 is “goals,” the corresponding text 118 may describe the company's goals.

The document 200 may follow any other template and include any categories 116, not limited to those described in FIG. 2, that relate to the organization's strategic or roadmap planning. In some implementations, the users 204 may edit the document 200 to add, change, or remove text from the categories 116 or other information on the document 200. In some implementations, multiple documents including the document 200 may be related to a single roadmap of the organization. For example, the organization may draft one document 120 per goal, key driver, or key output, depending on how much information is to be included. In such cases, all of the relevant documents may be provided to a visual representation platform, including an LLM, to generate a single visual representation of all the information in the documents.

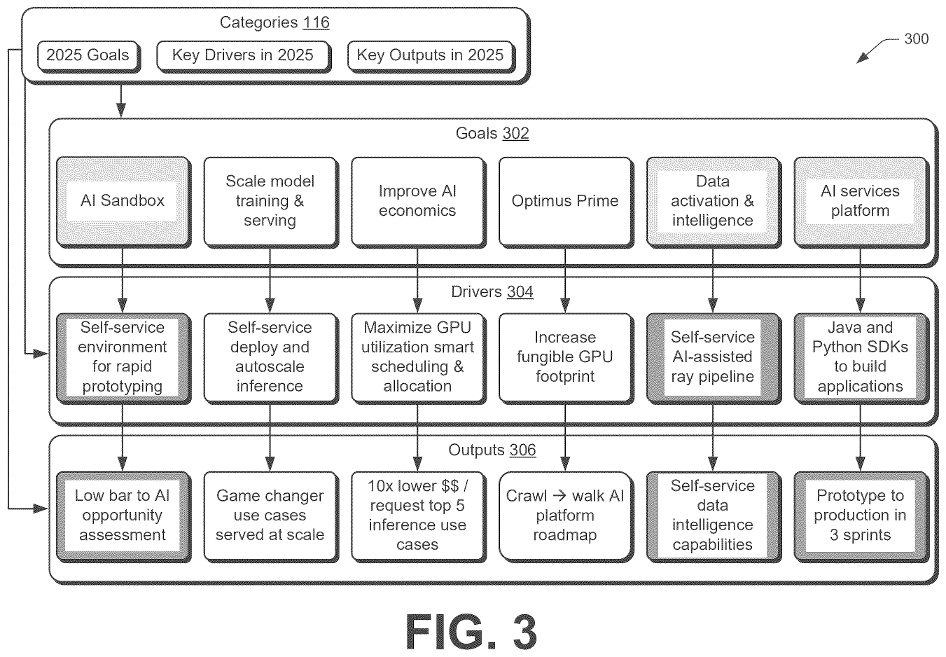

FIG. 3 depicts an example of a visual representation 300 in accordance with aspects of the present disclosure. The visual representation 300 may be implemented in or otherwise supported by the computing device 102, the service provider system 104, and the visual representation platform 106, as described with reference to FIG. 1. For example, the visual representation 300 may be an example of a visual representation 136 described herein with reference to FIG. 1. The visual representation 300 may depict information included in a document, such as the document 120 and the document 200 as described with reference to FIGS. 1 and 2.

The visual representation 300 depicts information related to an organization's strategic planning in the visual format of a chart (i.e., diagram). An underlying document on which the visual representation 300 is generated, such as the document 200 described herein with reference to FIG. 2, may include the categories 116, which correspond to executive-pertinent sections of the strategic plan. For example, the categories 116 may include “2025 Goals,” “Key Drivers in 2025,” and “Key Outputs in 2025.”

A visual representation platform may obtain the underlying document, which includes a template, the categories 116, and text detailing each of the categories 116, chunk and encode the content of the document, and generate a vector embedding index representing the document, which may be provided to an LLM. The LLM may distill sections of the document, for example, based on the categories 116. For example, the document may be distilled down into sections of goals 302 (corresponding to the category 2025 Goals), drivers 304 (corresponding to the category Key Drivers in 2025), and outputs 306 (corresponding to the category Key Outputs in 2025). Each distilled section may include relevant text.

In some implementations, the visual representation 300 may organize the information in the document in a simplified, streamlined manner. To do so, the LLM may use the distilled section and the vector embedding index to generate a file with a syntax, the syntax including instructions for generating the visual representation 300. By way of example, the document may specify that a department of the organization, AI services, focuses on the following in 2025: an AI sandbox, data activation and intelligence, and an AI services platform. Based on the syntax, a visualization module may generate the visual representation 300 to depict these three area of focus as elements in the goals 302 section, where the elements may be highlighted to represent that they are related to the AI services department. Other goals 302 depicted in the visual representation 300 may include scale model training and serving, improving AI economics, enabling Optimus Prime, and so forth.

Additionally, the document may detail goals and key drivers for 2025 for each of the focus areas. For example, goals and key divers related to the AI sandbox may include enabling and promoting unhindered AI-driven innovation, a self-service environment for rapid prototyping, ready to use application programming interfaces (APIs), vector search, and retrieval augmented generation (RAG) pipelines, tools to estimate quality and capacity, and so forth. The visual representation 300 may depict relevant goals and key drivers in respective sections of the chart, e.g., one of the drivers 304 is a self-service environment for rapid prototyping. Some drivers 304 and outputs 306 may also be highlighted based on their relation to each other, which may be detailed in the document. For example, elements highlighted in the visual representation 300 may be associated with a same department or team of the organization, related to similar goals, or otherwise associated, as indicated in the syntax.

Having discussed exemplary details of automatically generating visual representation of documents, consider now some examples of procedures to illustrate additional aspects of the techniques.

This section describes examples of procedures for automatically generating visual representation of documents for an organization. Aspects of the procedures may be implemented in hardware, firmware, or software, or a combination thereof. The procedures are shown as a set of blocks that specify operations performed by one or more devices and are not necessarily limited to the orders shown for performing the operations by the respective blocks.

FIG. 4 depicts a procedure 400 in an example implementation of automatically generating visual representation of documents in accordance with aspects of the present disclosure.

One or more documents that include information about strategic planning of an organization are obtained (block 402). By way of example, a user may create a document 120, where the document may follow a template 114 (e.g., a strategic planning framework) including categories 116 (e.g., business-pertinent sections), where each category 116 includes text 118 (e.g., information) about the organization in the context of that category 116.

A vector embedding index corresponding to the one or more documents is generated based on chunking and encoding content of the one or more documents (block 404). By way of example, the vector embedding index 124 may represent chunks of the document 120 in a vector format, where each chunk includes a quantity of characters of the text 118.

An LLM is executed to distill sections of the one or more documents and output a file based on the vector embedding index and the distilled sections, where the file comprises a syntax for generating a visual representation of the information (block 406). By way of example, the LLM 126 generate the distilled sections 128 based on the categories 116, e.g., each distilled section 128 may correspond to an executive-pertinent section. The syntax 132 may include information (e.g., textual descriptions) that enable a visualization module 134 or another diagramming and charting tool to generate the visual representation 136 of a document 120 based on the document 120 already being distilled into sections.

The visual representation of the information is sent for display via a user interface (block 408). By way of example, the visual representation 136 may depict information contained in the document 120 in a graphical, pictorial, illustrative, or other visual format. The visual representation 136 may be sent for display via a user interface of a computing device 102, e.g., such that the visual representation 136 may be shared and viewed by any member of the organization.

Having described examples of procedures in accordance with one or more implementations, consider now an example of a system and device that can be utilized to implement the various techniques described herein.

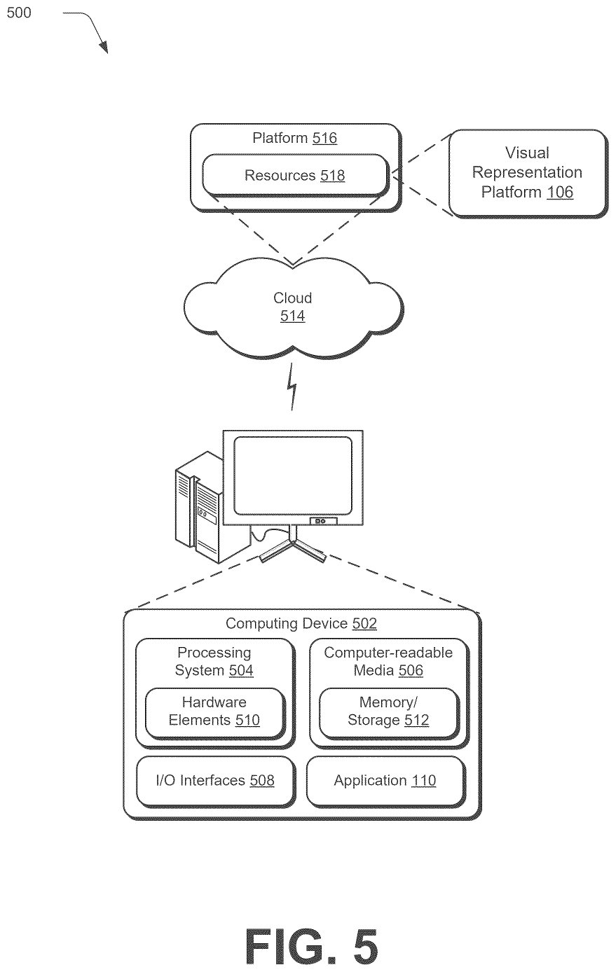

FIG. 5 illustrates an example of a system 500 generally that includes an example of a computing device 502 that is representative of one or more computing systems and/or devices that may implement the various techniques described herein. This is illustrated through inclusion of the application 110 and the visual representation platform 106. The computing device 502 may be, for example, a server of a service provider, a device associated with a client (e.g., a client device), an on-chip system, and/or any other suitable computing device or computing system.

The example computing device 502 as illustrated includes a processing system 504, one or more computer-readable media 506, and one or more I/O interfaces 508 that are communicatively coupled, one to another. Although not shown, the computing device 502 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 504 is representative of functionality to perform one or more operations using hardware. Accordingly, the processing system 504 is illustrated as including hardware elements 510 that may be configured as processors, functional blocks, and so forth. This may include implementation in hardware as an application specific integrated circuit or other logic device formed using one or more semiconductors. The hardware elements 510 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 506 is illustrated as including memory/storage 512. The memory/storage 512 represents memory/storage capacity associated with one or more computer-readable media. The memory/storage 512 may include volatile media (such as random access memory (RAM)) and/or nonvolatile media (such as read only memory (ROM), Flash memory, optical disks, magnetic disks, and so forth). The memory/storage 512 may include fixed media (e.g., RAM, ROM, a fixed hard drive, and so on) as well as removable media (e.g., Flash memory, a removable hard drive, an optical disc, and so forth). The computer-readable media 506 may be configured in a variety of other ways as further described below.

Input/output interface(s) 508 are representative of functionality to allow a user to enter commands and information to computing device 502, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 502 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 502. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 502, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 510 and computer-readable media 506 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 510. The computing device 502 may be configured to implement particular instructions and/or functions corresponding to the software and/or hardware modules. Accordingly, implementation of a module that is executable by the computing device 502 as software may be achieved at least partially in hardware, e.g., through use of computer-readable storage media and/or hardware elements 510 of the processing system 504. The instructions and/or functions may be executable/operable by one or more articles of manufacture (for example, one or more computing devices 502 and/or processing systems 504) to implement techniques, modules, and examples described herein.

The techniques described herein may be supported by various configurations of the computing device 502 and are not limited to the specific examples of the techniques described herein. This functionality may also be implemented all or in part through use of a distributed system, such as over a “cloud” 514 via a platform 516 as described below.

The cloud 514 includes and/or is representative of a platform 516 for resources 518. The platform 516 abstracts underlying functionality of hardware (e.g., servers) and software resources of the cloud 514. The resources 518 may include applications and/or data that can be utilized while computer processing is executed on servers that are remote from the computing device 502. Resources 518 can also include services provided over the Internet and/or through a subscriber network, such as a cellular or Wi-Fi network.

The platform 516 may abstract resources and functions to connect the computing device 502 with other computing devices. The platform 516 may also serve to abstract scaling of resources to provide a corresponding level of scale to encountered demand for the resources 518 that are implemented via the platform 516. Accordingly, in an interconnected device embodiment, implementation of functionality described herein may be distributed throughout the system 500. For example, the functionality may be implemented in part on the computing device 502 as well as via the platform 516 that abstracts the functionality of the cloud 514.

### CONCLUSION

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A computer-implemented method comprising:
obtaining one or more documents that include information about strategic planning of an organization;
generating a vector embedding index corresponding to the one or more documents based on chunking and encoding content of the one or more documents;
executing a large language model (LLM) to distill sections of the one or more documents and generate a file based on the vector embedding index and the distilled sections, wherein the file comprises a syntax for generating a visual representation of the information; and
sending, for display via a user interface, the visual representation of the information.

2. The computer-implemented method of claim 1, wherein the information is included in the one or more documents according to a template format.

3. The computer-implemented method of claim 2, wherein the template format is used to train the LLM.

4. The computer-implemented method of claim 1, wherein the syntax for generating the visual representation indicates one or more categories of the information, wherein the one or more categories relate to the strategic planning.

5. The computer-implemented method of claim 1, further comprising:
sending, to a visualization module, the file, wherein the visual representation is generated based on the syntax.

6. The computer-implemented method of claim 1, further comprising:
monitoring for at least one or more additional documents or a change to the information; and
generating an updated vector embedding index based on the at least one or more additional documents or the change to the information.

7. The computer-implemented method of claim 1, further comprising:
obtaining a plurality of documents including the one or more documents;
chunking and encoding the content within each of the plurality of documents by taking a plurality of characters of text within the content as a first chunk and overlapping a portion of the plurality of characters, and by taking a second plurality of characters of the text as a second chunk and overlapping a portion of the second plurality of characters to generate coherence across multiple chunks;
providing the chunked and encoded content to the vector embedding index;
based on providing the chunked and encoded content to the vector embedding index, utilizing the LLM to distill sections for the plurality of documents; and
sending, for display via the user interface, a distilled version of each of the plurality of documents into a standardized graphical user interface (GUI).

8. The computer-implemented method of claim 7, further comprising:
utilizing the LLM to distill the sections for the plurality of documents based on the vector embedding index utilizing the first chunk, the second chunk, and a chunk identifier for each of the first chunk and the second chunk to perform a reverse mapping.

9. The computer-implemented method of claim 7, wherein the plurality of characters and the second plurality of characters are below a threshold.

10. A system comprising:
one or more processors; and
memory storing instructions that, when executed by the one or more processors, cause the system to:
obtain one or more documents that include information about strategic planning of an organization;
generate a vector embedding index corresponding to the one or more documents based on chunking and encoding content of the one or more documents;
execute a large language model (LLM) to distill sections of the one or more documents and generate a file based on the vector embedding index and the distilled sections, wherein the file comprises a syntax for generating a visual representation of the information; and
send, for display via a user interface, the visual representation of the information.

11. The system of claim 10, wherein the information is included in the one or more documents according to a template format.

12. The system of claim 11, wherein the template format is used to train the LLM.

13. The system of claim 10, wherein the syntax for generating the visual representation indicates one or more categories of the information, wherein the one or more categories relate to the strategic planning.

14. The system of claim 10, wherein the instructions further cause the system to:
send, to a visualization module, the file, wherein the visual representation is generated based on the syntax.

15. The system of claim 10, wherein the instructions further cause the system to:
monitor for at least one or more additional documents or a change to the information; and
generate an updated vector embedding index based on the at least one or more additional documents or the change to the information.

16. The system of claim 10, wherein the instructions further cause the system to:
obtain a plurality of documents including the one or more documents;
chunk and encode the content within each of the plurality of documents by taking a plurality of characters of text within the content as a first chunk and overlapping a portion of the plurality of characters, and by taking a second plurality of characters of the text as a second chunk and overlapping a portion of the second plurality of characters to generate coherence across multiple chunks;
provide the chunked and encoded content to the vector embedding index;
based on providing the chunked and encoded content to the vector embedding index, utilize the LLM to distill sections for the plurality of documents; and
send, for display via the user interface, a distilled version of each of the plurality of documents into a standardized graphical user interface (GUI).

17. The system of claim 16, wherein the instructions further cause the system to:
utilize the LLM to distill the sections for the plurality of documents based on the vector embedding index utilizing the first chunk, the second chunk, and a chunk identifier for each of the first chunk and the second chunk to perform a reverse mapping.

18. The system of claim 17, wherein the plurality of characters and the second plurality of characters are below a threshold.

19. A non-transitory computer-readable media storing instructions that, when executed by one or more processors, cause the one or more processors to perform operations including:
obtaining one or more documents that include information about strategic planning of an organization;
generating a vector embedding index corresponding to the one or more documents based on chunking and encoding content of the one or more documents;
executing a large language model (LLM) to distill sections of the one or more documents and generate a file based on the vector embedding index and the distilled sections, wherein the file comprises a syntax for generating a visual representation of the information; and
sending, for display via a user interface, the visual representation of the information.

20. The non-transitory computer-readable media of claim 19, wherein the information is included in the one or more documents according to a template format.
